(19) United States
(12) Patent Application Publication
(10) Pub. No.: US 2026/0106646 A1
(43) Pub. Date: Apr. 16, 2026

(54) RECONFIGURABLE INTELLIGENT SURFACE INTEGRATED ON COMPACT DRONES FOR WIRELESS NETWORK SURVEY

(71) Applicant: Dell Products L.P., Round Rock, TX (US)

(72) Inventors: Tejinder Singh, Manotick (CA); Navjot Kaur Khaira, Manotick (CA); Seán Ahearne, Cork (IE)

(21) Appl. No.: 18/913,434

(22) Filed: Oct. 11, 2024

(51) Int. Cl. H04B 7/04; B64U 20/80; H04B 17/318

(52) U.S. Cl. CPC H04B 7/04013; H04B 17/328; B64U 20/80

(57) ABSTRACT

The technology described herein is directed towards deploying a reconfigurable intelligent surface mounted to a drone to facilitate wireless network communications. In one usage model, the drone can be moved around different candidate locations, in conjunction with controlling passive and/or active beamforming of the reconfigurable intelligent surface, to survey locations for deploying reconfigurable intelligent surfaces, e.g., on buildings at various locations (including various heights) in a dense urban environment. Passive beamforming can be accomplished by controllably tilting the reconfigurable intelligent surface. Further, the technology described herein can couple user equipment signals for communication with other non-terrestrial equipment, such as a low-earth orbit satellite or high-altitude platform station, via a drone-mounted reconfigurable intelligent surface, or a fixed reconfigurable intelligent surface at a deployment location determined via the drone-mounted surveying operations.

### RELATED APPLICATION

The subject patent application is related to U.S. patent application Ser. No. 18/780,254, filed Jul. 22, 2024, and entitled “TRANSCODING THE AIR-INTERFACE BETWEEN NON-TERRESTRIAL AND TERRESTRIAL NETWORKS LEVERAGING INTEGRATED TRANSCODER AND METASURFACE MOUNTED ON A DRONE” (docket no. 139018.01/DELLP1230US), the entirety of which patent application is hereby incorporated by reference herein.

### BACKGROUND

Terrestrial communication networks often struggle to provide wireless connectivity with high-speed data transmission and reliability, due to network capacity and coverage constraints. Because of their ability to redirect and alter the attributes of impinging signals, reconfigurable intelligent surfaces (RISes, alternatively referred to as intelligent reflective surfaces, or metasurfaces) are being evaluated for use in assisting fifth generation, beyond fifth generation (B5G) and sixth generation (6G) wireless communication and wireless sensing networks.

In general, reconfigurable intelligent surfaces (alternatively referred to as intelligent reflective surfaces, or metasurfaces) are man-made thin reflective or refractive surfaces whose electromagnetic response can be electronically controlled. Reconfigurable intelligent surfaces are characterized by their two-dimensional arrays of electronically controllable reflecting elements that can dynamically manipulate electromagnetic waves by altering attributes such as phase, amplitude, and direction of an incoming signal.

### BRIEF DESCRIPTION OF THE DRAWINGS

The technology described herein is illustrated by way of example and not limited to the accompanying figures in which like reference numerals indicate similar elements and in which:

FIG. 1 is a representation of an example metasurface (reconfigurable intelligent surface, or RIS) indoors mounted on a drone via separately extendable and retractable arms, in accordance with various example embodiments and implementations of the subject disclosure.

FIG. 2-4 are representations of example passive beamforming/signal redirection by extending and/or retracting individual arms of a RIS mounted on a drone, in accordance with various example embodiments and implementations of the subject disclosure.

FIG. 5 is a representation of an example environment in which a RIS mounted on a drone can be deployed to provide details related to terrestrial network signal coverage at differing locations, and/or to facilitate terrestrial communications, in accordance with various example embodiments and implementations of the subject disclosure.

FIG. 6 is a representation of an example urban environment in one or more which metasurfaces can be deployed, including on drones, for communication with a non-terrestrial network and/or a terrestrial network, in accordance with various example embodiments and implementations of the subject disclosure.

FIG. 7 is an example top view representation of an example unit-cell suitable for use in a metasurface that operates in a transmission mode or a reflection mode, in accordance with various example embodiments and implementations of the subject disclosure.

FIG. 8 is an example top view representation of an example metasurface panel that can be configured to operate in a transmission mode or a reflection mode, in accordance with various example embodiments and implementations of the subject disclosure.

FIG. 9 is a graphical representation of example transmission performance of unit cell(s) of a metasurface over various frequencies and beamforming directions, in accordance with various example embodiments and implementations of the subject disclosure.

FIG. 10 is a flow diagram showing example operations related to determining a selected location for RIS deployment based on deploying a drone with a RIS to different locations, in accordance with various example embodiments and implementations of the subject disclosure.

FIG. 11 is a flow diagram showing example operations related to obtaining a non-terrestrial signal as redirected by a drone in response to a terrestrial signal not satisfying a signal quality threshold, in accordance with various example embodiments and implementations of the subject disclosure.

FIG. 12 is a flow diagram showing example operations related to surveying signal quality data measured at candidate locations for a metasurface, including deploying a metasurface, coupled to a drone, to the respective candidate locations to obtain the signal quality data, in accordance with various example embodiments and implementations of the subject disclosure.

### DETAILED DESCRIPTION

The technology described herein is generally directed towards using non-terrestrial connected drones, integrated with a reconfigurable intelligent surface (RIS/metasurface), to facilitate wireless network communications. In one example scenario, such a drone with a coupled RIS can be used to facilitate comprehensive surveys with respect to determining optimal or near optimal placement and positioning of RIS panels that will be subsequently deployed. For example, a drone can come close to a building facade or window, and move around to measure signal quality data at different candidate locations, e.g., to measure parameters such as received signal strength indicator (RSSI), signal-to-interference-plus-noise ratio (SINR), and/or time of flight (ToF). The measured data can be used to select one or more deployment positions for deploying a RIS panel, and/or to create a detailed and accurate map of wireless coverage. At each candidate location, the RIS can be controlled mechanically and/or electrically to beamform the impinging signal in a redirection direction and/or with a determined beam width/array gain strength.

As will be seen, such a drone-mounted metasurface provides a strategy for optimal RIS deployment, e.g., by studying the RSSI and SINR at different location (including different heights) in urban scenarios. Further, wireless surveys can initially prioritize a terrestrial network, and if the signal strength is not good enough, a drone-mounted metasurface can leverage non-terrestrial network equipment for understanding low-network areas/spots. The data collected from these surveys can thus guide the strategic deployment of RIS panels, ensuring maximal signal reflection and optimal network performance in urban scenarios. This approach offers a practical and efficient method for network analysis and optimization, significantly improving urban wireless communication systems by addressing coverage gaps and enhancing signal quality.

Further, the integration of small size RIS panels on compact drones can act as mobile relay nodes to enhance the coverage and dependability of terrestrial communication systems. A THz or sub-THz RIS is formed by a two-dimensional periodic array of unit-cells. This can be for enhancing terrestrial communications, as well as for facilitating non-terrestrial communications, e.g., with a low-earth orbit satellite or other high altitude equipment.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

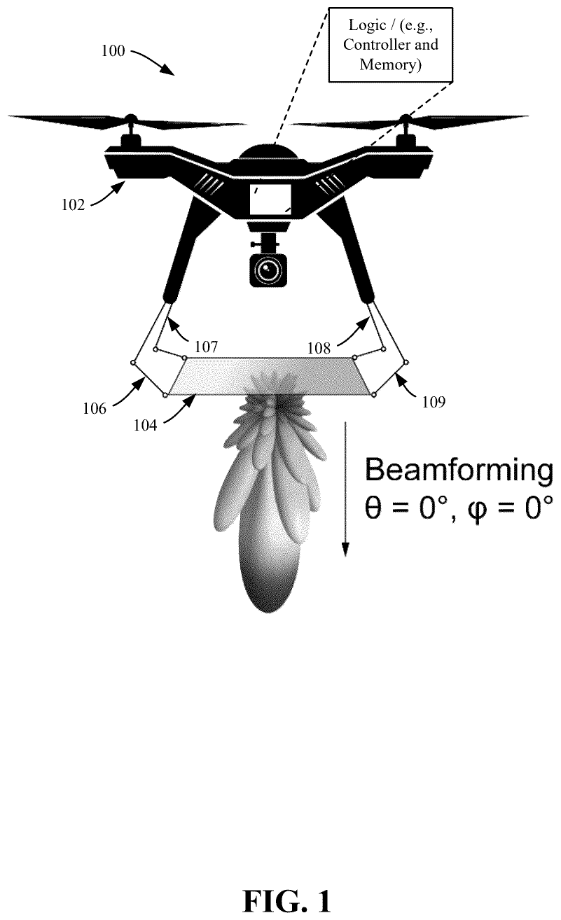

FIG. 1 is a representation of an example system 100 including drone 102 to which a RIS (metasurface) 104 is coupled. In the example system, four articulatable arms or flexures 106 109 can be separately controlled with respect to their lengths, that is, they can be individually (or pairwise) extended (bent straighter) or retracted (compressed). In this example, logic (e.g., corresponding to a controller and memory) 110 in the drone 102 can control respective lengths of the respective arms 106-109 and thereby tilt the RIS 104 relative to the drone 102. Note that instead of articulatable arms, other mechanical ways to tilt the metasurface are feasible, e.g., linear actuators (leadscrews) that are extensible and retractable via controlled (e.g., motor rotation), mounts that couple the RIS 104 to the drone 102 via controlled-length telescoping poles, and so on.

In any event, in one implementation, the RIS 104 is carried on the drone 102 using four controlled-length arms 106-109 (which can be articulatable flexures) that mount the RIS 104 such that they do not block the view of the camera 112 (or cameras) on the bottom surface of the drone 102, e.g., as shown in FIG. 1. Such arms/flexures can be made using lightweight, low-cost non-conductive material; the designs can be additively manufactured.

As shown in FIG. 1-4, each of the flexures 106-109 can be individually elongated or compressed such that the RIS panel can be tilted as desired, e.g., to capture respective signal strength data based on RIS deployment at various candidate locations. More particularly, by controlling the four adjustable flexures 106-109, the reflection, refraction, and/or phase of the passive reflecting elements can be adjusted in real time to steer the incident electromagnetic signals in a desired direction. The phase and amplitude of the reflected signal can maximize the effective channel gain in the intended direction as shown in FIG. 1-4.

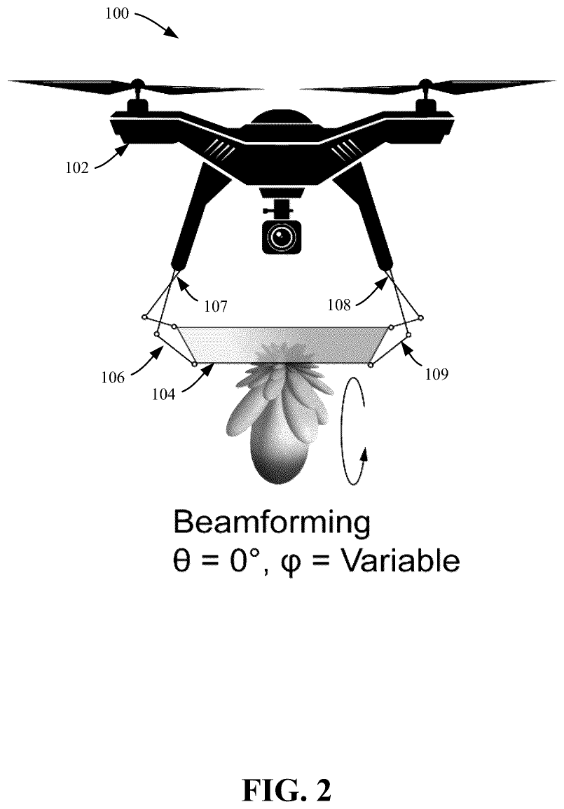

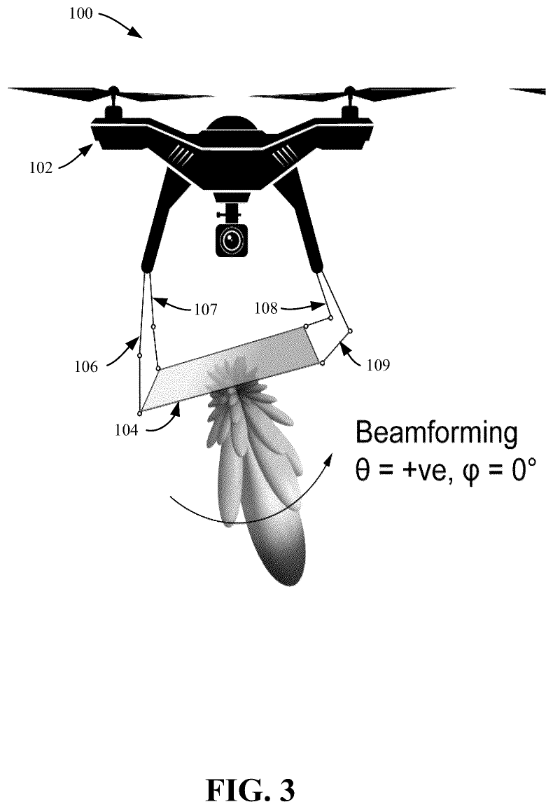

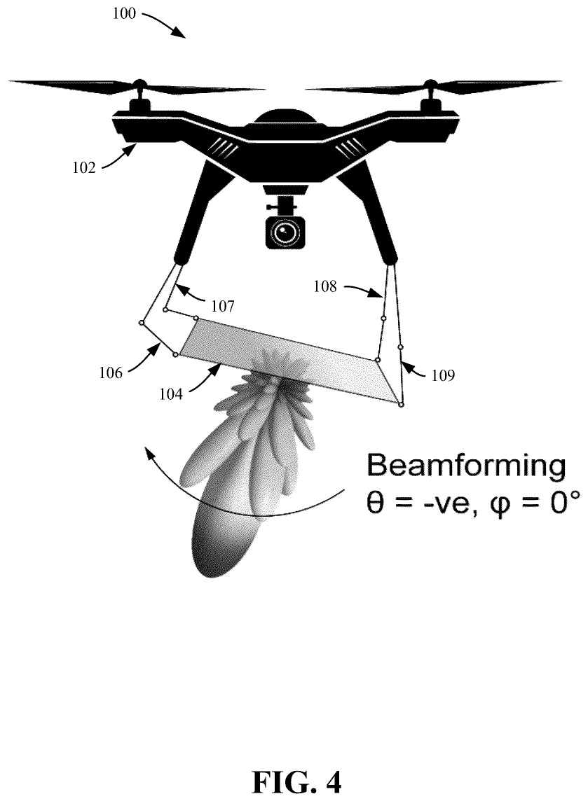

In the examples of FIG. 1-4, the azimuth (φ) and elevation angle (θ) of the reflected beam can be changed by tilting the RIS panel in the Y-direction and/or X-direction, respectively. When the RIS panel is aligned parallel to the ground, the beamforming direction is in the broadside (θ=0°, φ=0 °) as shown in FIG. 1. When the RIS panel is tilted in Y-direction only, the reflected beam is in the direction θ=0°, φ=variable (depending on the amount of Y-direction tilting, FIG. 2). By tilting the RIS panel in the X-direction only (FIGS. 3 and 4), the resulting reflected beam is achieved in the direction θ=variable (depending on the amount of X-direction tilting), φ=0°. There is thus facilitated passive beamforming using RIS on drone by compressing or extending individual or pairs of flexures.

Alternatively (or in addition to) such a mechanically-controlled passive beamforming approach using variable-length arms, an active RIS can be used with electronic control of the beam; an effective and efficient solution depends on the power consumption requirements, however controlling individual phases of unit cells to perform beamforming does not add substantial weight. Indeed, while compact drones cannot carry too much weight, passive, active or hybrid (passive and active) beamforming as described herein adds only a few grams of weight to the drone. A tethered drone, limited to a smaller evaluation area, would be needed if heavy equipment such as a spectrum analyzer was used for such a survey.

Indeed, while deploying metasurface in urban environments with high availability of connectivity is desired, having an individual carry a spectrum analyzer (e.g., while walking down surrounding streets) does not sufficiently measure radio coverage, nor does it account for signal quality data at different heights. In dense urban environments, there are typically office spaces and/or apartments where user equipment need to be connected at any time.

Instead, as described herein, a fully passive, active or hybrid RIS panel can be used, whereby a compact drone, without tethering, is a suitable solution for measuring signal quality data for many scenarios, given that such a RIS facilitates extended mobility, e.g., to survey dense urban streets and at different altitudes. For example, a RIS deployed on a building window can directly provide coverage indoors, as long as the placement of the RIS panel is correctly planned.

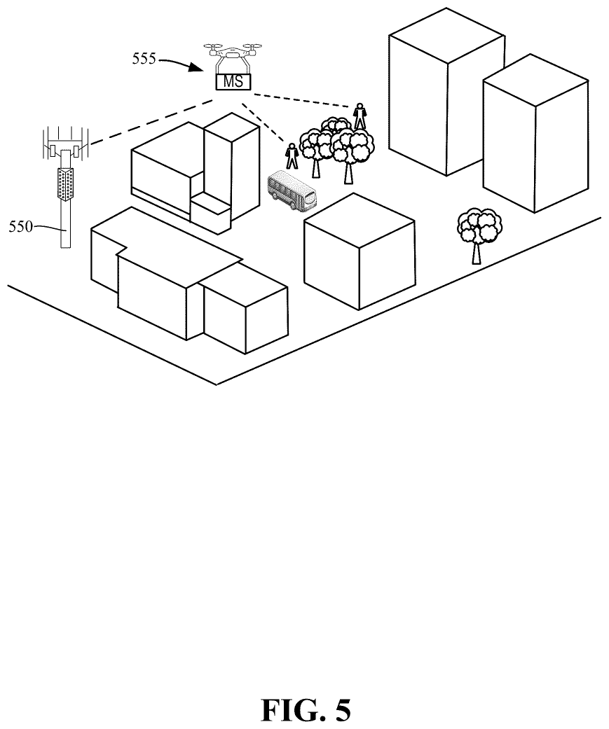

Further, a terrestrial connected drone with a connected RIS can also be used to provide radio coverage to users by redirecting signals towards weak spots, such as shown in the example environment of FIG. 5. In FIG. 5, radio coverage from a base station 550 is limited because of the weaker coverage or shadow spots in dense urban environments with tall buildings, however the use of a drone-mounted RIS 555 can provide coverage to such weaker coverage areas. Moreover, one or more such drone-mounted metasurfaces can provide connectivity to an area for a short term needs, such as in case of a disaster where regular coverage is not available, or during an event such as a concert.

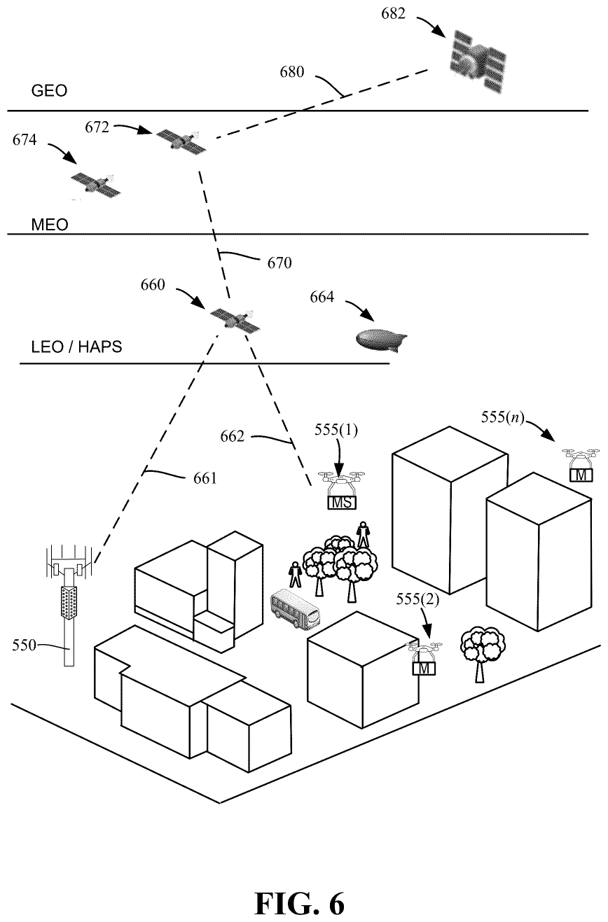

One further use of the technology described herein is to deploy non-terrestrial connected drones, with integrated metasurfaces, to survey or communicate in the urban environment at different locations/heights. The drones (e.g., 555(1)-555(n) can be connected through the base station 550 as long as the drones receive enough RSSI and SINR from the base station 550. In case the performance drops below a defined signal quality data threshold, any terrestrial connection can be shifted directly to a non-terrestrial network node, e.g., a low-earth orbit (LEO) satellite 660 (e.g., via the LEO-base station link 661 and the LEO/HAPS—(high-altitude platform station) drone link 662), or other high-altitude platform station (HAPS) 664 as shown in FIG. 6. Other possible links depicted in FIG. 6 include a mid-earth orbit (MEO)-to-LEO link 670 to a MEO satellite 672 (or a MEO satellite 674), and a geostationary earth orbit (GEO)-to-MEO link 680 to GEO satellite 682.

Thus, as shown in FIG. 6, the LEO/HAPS equipment can be an all-time terrestrial connected to the base station 550, or a hybrid of terrestrial and non-terrestrial connected nodes where the signals can hop from the base station 550 to the LEO/HAPS layers. From the LEO / HAPS layers, signals can be communicated between the medium earth orbit (MEO) layer followed by a connection to geostationary equatorial orbit (GEO) satellite. Note that while a drone-mounted reconfigurable intelligent surface is shown in FIG. 6, surveying as described herein can be used to determine a location for deploying a fixed reconfigurable intelligent surface to communicate with LEO satellites or other HAPS equipment.

Turning to metasurfaces and their unit cells in general, the metallic patterns (sub-wavelength scatterers) or simply the unit cell resonators can be fabricated on a cost-effective FR4 substrate or silicon substrate, for example. The reflected beam direction depends on the phase profile of the RIS; in other words, the reflection (or refraction) phase from each unit cell is selected in a manner such that it provides constructive interference in a desired direction, as well as being able to result in a narrower or a wider redirected beam.

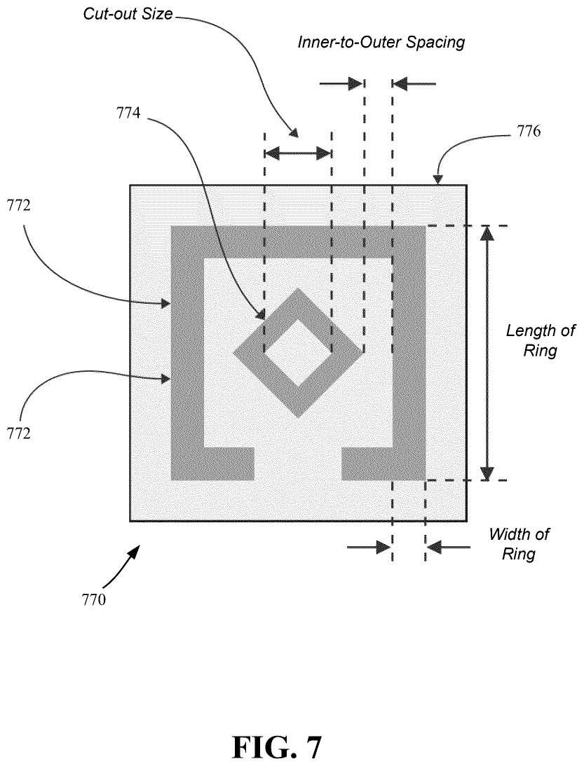

FIG. 7 shows one example design of a unit cell 770 of a metasurface. In this example, the unit cell 770 has a metallic resonating pattern shaped as square split ring (outer shape 772) with a central rhombus (inner shape 774). The pattern is formed from a thin metal film on a dielectric substrate 776. The dimensions of the unit cell 770 determine the frequency at which the unit cell resonates, and are thus sized based on the frequency band of the incoming signal. Smaller dimensions can be used for higher frequencies, such as millimeter wave/FR2 frequencies. Note that FIG. 7 is only one non-limiting example, and that the metallic resonator pattern of a unit cell can be of any shape and size as long as the metallic resonator pattern resonates at the desired frequency.

Scaling of the rhombus shape, or by rotating the inner shape 774, allows the phase of the unit-cell to be tweaked; in this way, a metasurface's unit cells can be coded as per the phase-codebook of the metasurfaces for beam redirection, given an incoming signal from a known general direction relative to the metasurface, e.g., from the sky for a satellite. Various design dimensions are shown in FIG. 7 to better illustrate the optimization variables. This shape of the unit-cell can be developed on any choice of commonly available dielectrics including but not limited to FR4 laminates, Rogers RF substrates, alumina, sapphire, glass, ceramics, or other non-metallic substrates, as long as the unit-cell shows a resonance peak at the desired frequency.

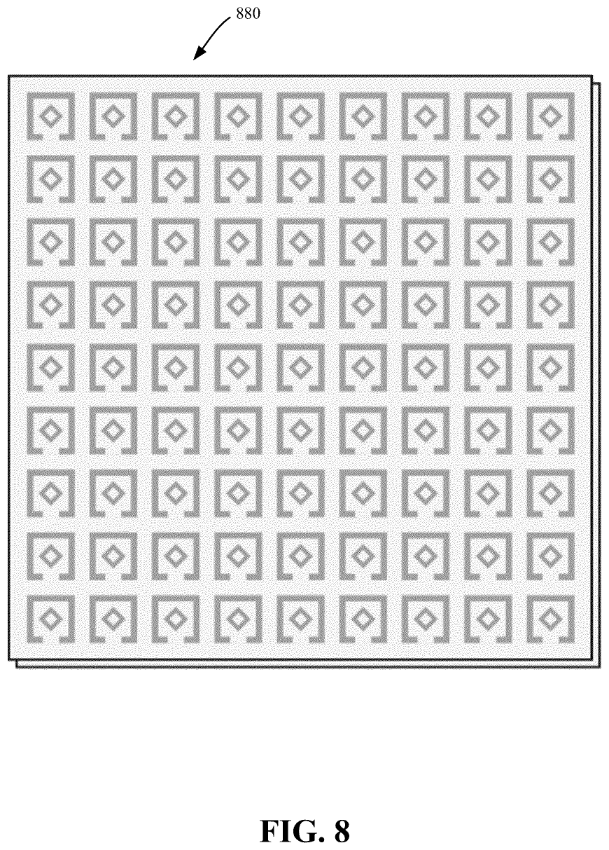

FIG. 8 shows the concept of a metasurface 880 of unit cells. The metasurface 880 can be configured or designed to operate in a reflection mode that reflects the impinging signals in a beamforming direction corresponding to the states of the unit cells, or refracts the impinging signals when configured or designed to operate in a transmission mode.

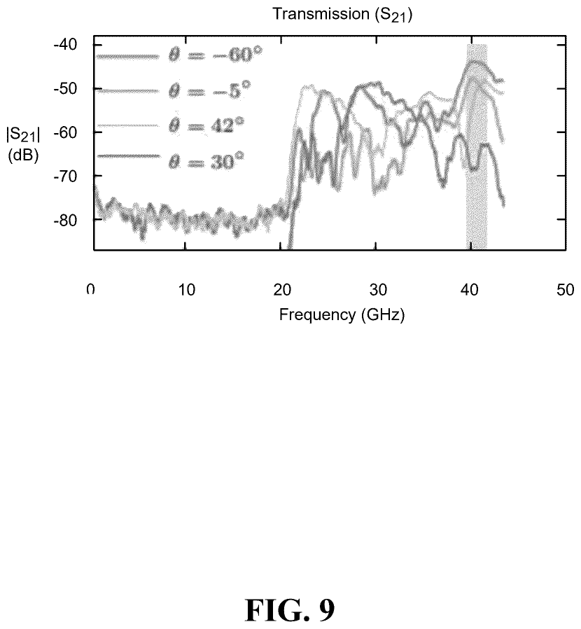

FIG. 9 shows the EM transmission of one or more unit cells over various frequencies. The results for four different elevation angles (θvalues of −65°, −5°, 42° and 30°) are shown.

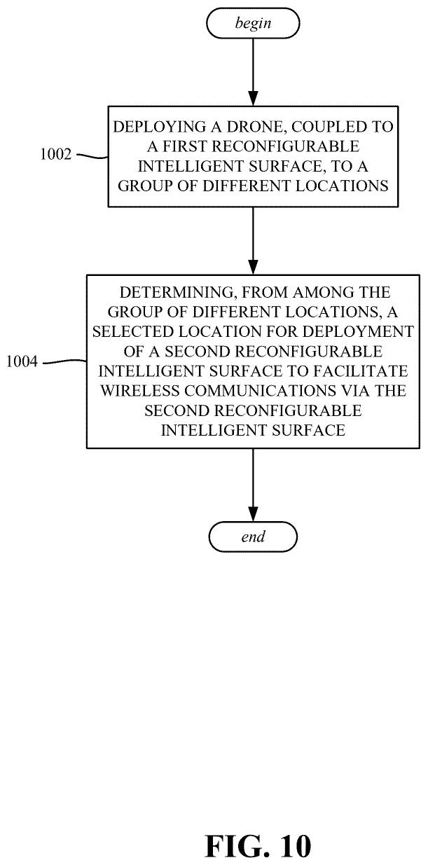

One or more implementations and embodiments can be embodied in a system, such as described and represented in the example operations of FIG. 10, and for example can include at least one memory that stores computer executable components and/or operations, and at least one processor that executes computer executable components and/or operations stored in the at least one memory. Example operations can include operation 1002, which represents deploying a drone, coupled to a first reconfigurable intelligent surface, to a group of different locations. Example operation 1004 represents determining, from among the group of different locations, a selected location for deployment of a second reconfigurable intelligent surface to facilitate wireless communications via the second reconfigurable intelligent surface.

The first reconfigurable intelligent surface can be coupled to the drone via an arm, and determining the selected location can include orienting the reconfigurable intelligent surface relative to the drone, which can include controlling a length of the arm.

The first reconfigurable intelligent surface can be coupled to the drone via four respective arms, and determining the selected location can include orienting the reconfigurable intelligent surface relative to the drone, comprising which can include controlling at least one respective length of the four respective arms.

Determining the selected location can include controlling unit cells of the reconfigurable intelligent surface to electrically beamform a signal redirected from the reconfigurable intelligent surface based on an impinging electromagnetic wave.

Determining the selected location can include measuring respective signal quality data representative of respective signal qualities at respective locations of the group of different locations, and evaluating the respective signal quality data to determine the selected location for the deployment of the second reconfigurable intelligent surface.

The respective signal quality data can include at least one of: respective received signal strength indicator data representative of respective received signal strength indicators at the respective locations, respective reference signal received quality data representative of respective reference signal received qualities at the respective locations, respective reference signal received power data representative of respective reference signal received powers at the respective locations, respective signal-to-noise ratio data representative of respective signal-to-noise ratios at the respective locations, respective signal-plus-interference-to-noise ratio data representative of respective signal-plus-interference-to-noise ratios at the respective locations, or respective time-of-flight data representative of respective time-of-flights applicable to the respective locations.

The respective signal quality data can correspond to signals from a terrestrial network.

The respective signal quality data can correspond to signals from a non-terrestrial network.

Respective locations of the group of different locations can include different heights.

Deployment of the second reconfigurable intelligent surface can include the deployment of a second drone coupled to the first reconfigurable intelligent surface.

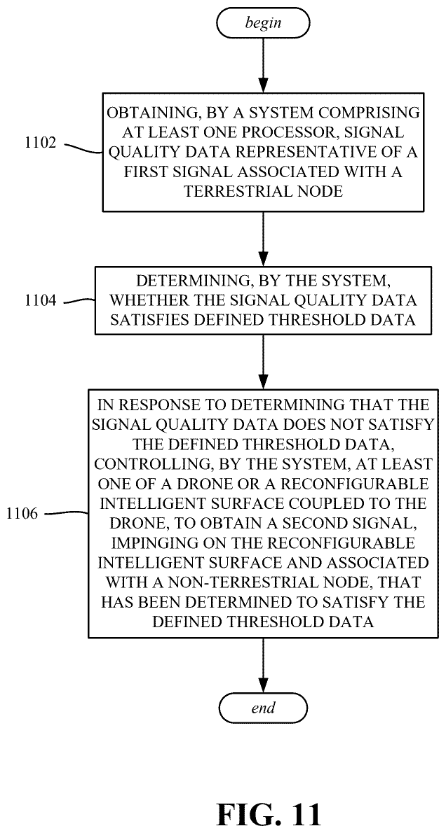

One or more example implementations and embodiments, such as corresponding to example operations of a method, can be represented in FIG. 11. Example operation 1102 represents obtaining, by a system comprising at least one processor, signal quality data representative of a first signal associated with a terrestrial node (which may or may not be redirected by a reconfigurable intelligent surface, possibly a reconfigurable intelligent surface mounted to a drone. Example operation 1104 represents determining, by the system, whether the signal quality data satisfies defined threshold data. Example operation 1106 represents, in response to determining that the signal quality data does not satisfy the defined threshold data, controlling, by the system, at least one of a drone or a reconfigurable intelligent surface coupled to the drone, to obtain a second signal, impinging on the reconfigurable intelligent surface and associated with a non-terrestrial node, that has been determined to satisfy the defined threshold data.

Controlling the at least one of the drone or the reconfigurable intelligent surface can include changing a length of at least one arm via which the reconfigurable intelligent surface can be mechanically coupled to the drone to tilt the reconfigurable intelligent surface relative to the drone.

Changing the length of the at least one arm can include extending or retracting the at least one arm relative to the drone.

Controlling the at least one of the drone or the reconfigurable intelligent surface can include electrically controlling unit cells of the reconfigurable intelligent surface to redirect the second signal to a receiving device.

The signal quality data representative of the first signal can include first signal quality data, controlling of the at least one of the drone or the reconfigurable intelligent surface to obtain the second signal can be a first controlling, and further operations can include, determining, by the system, that second signal quality data associated with the terrestrial node satisfies the defined threshold data, and second controlling, by the system, the at least one of the drone or the reconfigurable intelligent surface, to obtain a third signal, associated with the terrestrial node, for redirection of the third second signal to the receiving device.

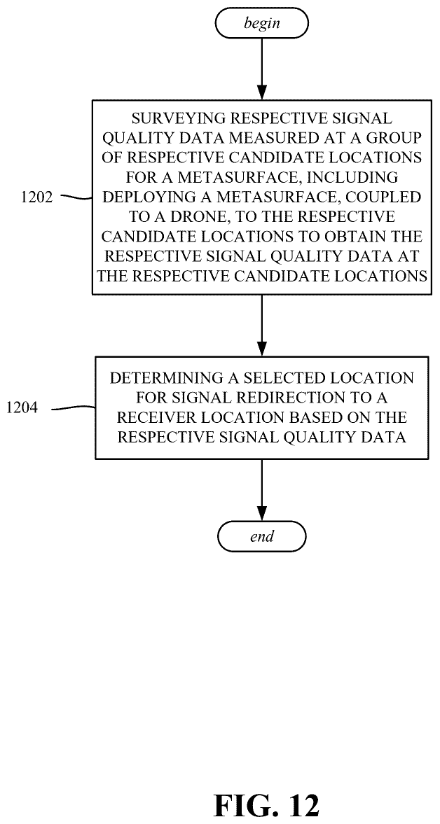

FIG. 12 summarizes various example operations, e.g., corresponding to a machine-readable medium, including executable instructions that, when executed by at least one processor, facilitate performance of operations. Example operation 1202 represents surveying respective signal quality data measured at a group of respective candidate locations for a metasurface, including deploying a metasurface, coupled to a drone, to the respective candidate locations to obtain the respective signal quality data at the respective candidate locations. Example operation 1204 represents determining a selected location for signal redirection to a receiver location based on the respective signal quality data.

Further operations can include, while the metasurface can be located at a respective candidate location of the respective candidate locations, controlling signal redirection by the metasurface to respective different redirection directions to measure a respective group of signal quality datasets at the respective candidate location, and wherein the determining of the selected location for signal redirection to the receiver location based on the respective signal quality data can be based on the respective group of signal quality datasets.

The metasurface can be mechanically tiltable relative to the drone, and wherein the controlling of the signal redirection can include mechanically tilting the metasurface relative to the drone.

Controlling the signal redirection can include electrically controlling unit cells of the metasurface to redirect impinging signals to the respective different redirection directions.

Surveying of respective signal quality data can include measuring, as the respective signal quality data, at least one of: respective received signal strength indicator data, respective reference signal received quality data, respective reference signal received power data, respective signal-to-noise ratio data, respective signal-plus-interference-to-noise ratio data, or respective time-of-flight data.

As can be seen, the technology described herein provides drone-mountable metasurface (RIS) technology that is beneficial for determining optimal or near-optimal locations for RIS deployment. A surveying process can be almost entirely automated, as compact commercial drones with relatively inexpensive cost can follow a predetermined path with obstacle avoidance sensors built in. Based on the predefined path, the drones can survey three-dimensional regions / areas with minimal intervention. Note that actual deployments for experimental purposes, without the use of heavy spectrum analyzers and any tethering connection to drones, have been successful.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
deploying a drone, coupled to a first reconfigurable intelligent surface, to a group of different locations; and
determining, from among the group of different locations, a selected location for deployment of a second reconfigurable intelligent surface to facilitate wireless communications via the second reconfigurable intelligent surface.

2. The system of claim 1, wherein the first reconfigurable intelligent surface is coupled to the drone via an arm, and wherein the determining of the selected location comprises orienting the reconfigurable intelligent surface relative to the drone, comprising controlling a length of the arm.

3. The system of claim 1, wherein the first reconfigurable intelligent surface is coupled to the drone via four respective arms, and wherein the determining of the selected location comprises orienting the reconfigurable intelligent surface relative to the drone, comprising controlling at least one respective length of the four respective arms.

4. The system of claim 1, wherein the determining of the selected location comprises controlling unit cells of the reconfigurable intelligent surface to electrically beamform a signal redirected from the reconfigurable intelligent surface based on an impinging electromagnetic wave.

5. The system of claim 1, wherein the determining of the selected location comprises measuring respective signal quality data representative of respective signal qualities at respective locations of the group of different locations, and evaluating the respective signal quality data to determine the selected location for the deployment of the second reconfigurable intelligent surface.

6. The system of claim 5, wherein the respective signal quality data comprises at least one of: respective received signal strength indicator data representative of respective received signal strength indicators at the respective locations, respective reference signal received quality data representative of respective reference signal received qualities at the respective locations, respective reference signal received power data representative of respective reference signal received powers at the respective locations, respective signal-to-noise ratio data representative of respective signal-to-noise ratios at the respective locations, respective signal-plus-interference-to-noise ratio data representative of respective signal-plus-interference-to-noise ratios at the respective locations, or respective time-of-flight data representative of respective time-of-flights applicable to the respective locations.

7. The system of claim 5, wherein the respective signal quality data corresponds to signals from a terrestrial network.

8. The system of claim 5, wherein the respective signal quality data corresponds to signals from a non-terrestrial network.

9. The system of claim 1, wherein respective locations of the group of different locations comprise different heights.

10. The system of claim 1, wherein the deployment of the second reconfigurable intelligent surface comprises the deployment of a second drone coupled to the first reconfigurable intelligent surface.

11. A method, comprising:
obtaining, by a system comprising at least one processor, signal quality data representative of a first signal associated with a terrestrial node;
determining, by the system, whether the signal quality data satisfies defined threshold data; and
in response to determining that the signal quality data does not satisfy the defined threshold data, controlling, by the system, at least one of a drone or a reconfigurable intelligent surface coupled to the drone, to obtain a second signal, impinging on the reconfigurable intelligent surface and associated with a non-terrestrial node, that has been determined to satisfy the defined threshold data.

12. The method of claim 11, wherein the controlling of the at least one of the drone or the reconfigurable intelligent surface comprises changing a length of at least one arm via which the reconfigurable intelligent surface is mechanically coupled to the drone to tilt the reconfigurable intelligent surface relative to the drone.

13. The method of claim 12, wherein the changing of the length of the at least one arm comprises extending or retracting the at least one arm relative to the drone.

14. The method of claim 11, wherein the controlling of the at least one of the drone or the reconfigurable intelligent surface comprises electrically controlling unit cells of the reconfigurable intelligent surface to redirect the second signal to a receiving device.

15. The method of claim 11, wherein the signal quality data representative of the first signal comprises first signal quality data, wherein the controlling of the at least one of the drone or the reconfigurable intelligent surface to obtain the second signal is a first controlling, and further comprising, determining, by the system, that second signal quality data associated with the terrestrial node satisfies the defined threshold data, and second controlling, by the system, the at least one of the drone or the reconfigurable intelligent surface, to obtain a third signal, associated with the terrestrial node, for redirection of the third second signal to the receiving device.

16. A non-transitory machine-readable medium, comprising executable instructions that, when executed by at least one processor, facilitate performance of operations, the operations comprising:
surveying respective signal quality data measured at a group of respective candidate locations for a metasurface, comprising deploying a metasurface, coupled to a drone, to the respective candidate locations to obtain the respective signal quality data at the respective candidate locations; and
determining a selected location for signal redirection to a receiver location based on the respective signal quality data.

17. The non-transitory machine-readable medium of claim 16, wherein the operations further comprise, while the metasurface is located at a respective candidate location of the respective candidate locations, controlling signal redirection by the metasurface to respective different redirection directions to measure a respective group of signal quality datasets at the respective candidate location, and wherein the determining of the selected location for signal redirection to the receiver location based on the respective signal quality data is based on the respective group of signal quality datasets.

18. The non-transitory machine-readable medium of claim 17, wherein the metasurface is mechanically tiltable relative to the drone, and wherein the controlling of the signal redirection comprises mechanically tilting the metasurface relative to the drone.

19. The non-transitory machine-readable medium of claim 17, wherein the controlling of the signal redirection comprises electrically controlling unit cells of the metasurface to redirect impinging signals to the respective different redirection directions.

20. The non-transitory machine-readable medium of claim 16, wherein the surveying of the respective signal quality data comprises measuring, as the respective signal quality data, at least one of: respective received signal strength indicator data, respective reference signal received quality data, respective reference signal received power data, respective signal-to-noise ratio data, respective signal-plus-interference-to-noise ratio data, or respective time-of-flight data.
